(19) United States
(12) Patent Application Publication
(10) Pub. No.: US 2010/0239366 A1
(43) Pub. Date: Sep. 23, 2010

(54) Connecting device and method for creating a connection

(75) Inventors: Oliver Bahr, St. Gallen (CH); Alexander Claus, Feldkirch (AT); Joachim Vedder, Hergensweiler (DE)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/661,662

(22) Filed: Mar. 22, 2010

(30) Foreign Application Priority Data
Mar. 23, 2009 (DE) DE 102009001749.6

(51) Int. Cl. F16B 7/00; B23P 17/04

(52) U.S. Cl. 403/268; 29/527.1

(57) ABSTRACT

A connecting device (21) for non-positively joining a first structural element (11) to a second structural element (16) comprises a hollow body (22) that forms a cavity (23) and that has an insertion opening (24) for inserting a joining element (36). An anchoring agent (31) for anchoring the joining element (36) that is inserted into the cavity (23) is provided in the cavity (23) of the hollow body (22), whereby the anchoring agent (31; 61) and the hollow body (22) together form a prefabricated unit. Furthermore, the invention relates to a method for creating a connection with such a connecting device.

This claims the benefit of German Patent Application DE 10 2009 001 749.6, filed Mar. 23, 2009 and hereby incorporated by reference herein.

The invention relates to a connecting device for non-positively joining a first structural element to a second structural element. Moreover, the invention relates to a method for creating a connection.

### BACKGROUND

Poured structural elements such as walls, floors and the like made of concrete are provided with reinforcement in order to withstand tensile forces. Due to the construction work sequence or the dimensions of these structural elements, they often cannot be produced in a single pouring step or monolithically. In such cases, daywork joints such as construction joints are provided so that a first structural element is made first, and subsequently, the second structural element is made at a later point in time, which is adjacent to the first structural element. In this process, it must be ensured that all of the forces that act on the entire structural element can be transmitted via this separation joint.

In order to create a non-positive join between the two structural elements, so-called overlapping joints are known in which reinforcing bars of the first structural element protrude with the requisite anchoring length through the formwork of the concrete construction joint.

A drawback of the known solution is that the through-openings that are present in the formwork for the reinforcing bars have to be carefully sealed since otherwise, cement slurry, which consists of water and fine particles of the still-fluid concrete, can leak via these through-openings. If this cement slurry is absent in a given area, for example, in the formwork, so-called gravel pockets are created that form a region of the structural element with diminished load-bearing capacity and that are also esthetically undesired. Moreover, the reinforcing bars protruding from the formwork pose a danger to the user and can even hinder the further course of the construction work sequence.

German Utility Model 296 14 733 U1 describes a connecting device for non-positively joining a first structural element to a second structural element, comprising a hollow body that forms a cavity and that has an insertion opening for inserting a rod-shaped joining element such as a reinforcing bar. The sleeve-like hollow body is arranged on the formwork of the first structural element in such a way that its insertion opening comes to lie approximately in the plane of the surface of the completed first structural element. In order to create the connection, the cavity of the hollow body is first filled with a curable compound, e.g. with cement mortar as an anchoring agent, and subsequently a reinforcing bar is inserted into it as the joining element. After the curable compound has cured, the joining element is non-positively anchored in the first structural element, and thus the subsequently made second structural element is joined to the first structural element via this non-positive join in order to transmit the exerted forces that are exerted.

A drawback of the known solution is that the curable compound has to be taken along separately and applied at the construction site. This adds to the effort involved in creating the connection and also entails additional logistical work.

### SUMMARY OF THE INVENTION

It is an object of the present invention to provide a connecting device for creating a non-positive join between a first structural element and a second structural element, as well as a method for creating a connection that allows a simple creation of the connection and that avoids the above-mentioned drawbacks.

The present invention provides a connecting device for non-positively joining a first structural element to a second structural element, whereby the connecting device comprises a hollow body that forms a cavity and that has an insertion opening for inserting a joining element.

According to the invention, an anchoring agent for anchoring the joining element that can be inserted into the cavity is provided in the cavity of the hollow body, at least in certain areas thereof, whereby the anchoring agent and the hollow body together form a prefabricated unit.

The connecting device forms an essentially closed container that can be installed as a unit. The anchoring agent is already present in the hollow body before the connecting device is placed, for example, onto the formwork of the first structural element. The user does not have to carry along a separate anchoring agent and does not have to perform an additional work step in order to place it into the hollow body. The joining element that can be inserted into the hollow body is anchored directly in the hollow body poured into the first structural element. The work for creating the connection is considerably reduced in comparison to the conventional solutions. Moreover, depending on the internal dimensions of the cavity, all of the usual diameters of joining elements, especially of reinforcing bars, can be used, since they no longer have to be bent into the desired alignment after being installed in the first structural element. Since no reinforcing bars protrude from the first structural element until the production of the second structural element, the construction work sequence is in no way hindered by the connection. Moreover, a joining element that has been inserted into the hollow body can be aligned, at least to a certain extent.

Moreover, due to the clearly definable anchoring forces, the anchoring length of the joining element in the first structural element can be considerably reduced in comparison to a solution involving subsequent drilling, thus lowering the required amount of material and the costs for the individual parts of the connecting device and of the joining element that is used together with it. The geometry and especially the axial length of the hollow body are defined as a function of the forces that are to be transmitted. In the case of a daywork joint by means of which, for example, mainly shear forces are transmitted, the axial length of the hollow body can be configured to be shorter than in the case of a daywork joint by means of which, for example, mainly tensile forces have to be transmitted.

In this context, the term joining elements means not only reinforcing bars but also all other kinds of elements that are suitable for creating a non-positive join between the first structural element and the second structural element. In addition to the subsequently produced structural elements, the second structural element can also be a girder or a machine that is non-positively joined to the first structural element by means of the joining element. For example, threaded rods or head studs are used as joining elements. Advantageously, the joining element is rod-shaped. Furthermore, the free end of the joining element can be provided with a connecting section, such as a screwed thread or a coupler, onto which an additional element such as, for example, a bent-down reinforcing bar or an anchoring plate can be connected. Moreover, for instance, an anchored joining element can also serve to connect binder elements or reinforcing cages that are embedded in the second structural element. In addition to metallic joining elements, it is also possible to use non-metallic materials such as plastic.

The connecting device according to the invention can be used, for example, for wall-to-wall, wall-to-floor, floor-to-floor or pillar-to-floor joins, or else for openings that have to be closed off at a later point in time, whereby these cited examples are not the only ones. Consequently, the connecting device is suitable for all kinds of joins for two structural elements that can be produced at different points in time. In addition to poured structural elements made, for example, of concrete, the connecting device according to the invention can also be provided for masonry structural elements. For this purpose, the hollow body is installed with the anchoring agent by means of a masonry process when the structural element is made, or else it is poured into said first structural element. Then, before the second structural element, which is adjacent to the first structural element, is made, the appropriately suitable joining element, for example, masonry reinforcement, is anchored in the connecting device, and then the second structural element is made, for instance, by means of a masonry or pouring process.

Preferably, the anchoring agent comprises a curable compound that, after it has cured, ensures an advantageous non-positive anchoring of the joining element that has been inserted into the hollow body. The curing of the curable compound is initiated or brought about by external influences such as, for example, exposure to air, water, etc., or else by the application of radiation such as, for instance, heat, UV light, etc.

Preferably, the curable compound comprises several components that are advantageously mixed when the joining element is inserted, whereby the curing process of the curable compound is started at this time. This connecting device stands out for its high and prolonged storage stability. The individual components are arranged, for example, in a corresponding number of containers in the cavity of the hollow body. For instance, at least one of the components—advantageously the component that starts the curing process of the curable compound—is microencapsulated in the at least one additional component. In an advantageous variant, for example, the container with the first component is arranged directly in the container with the other component. For instance, the insertion end of the joining element that can be inserted into the cavity has a mixing element for mixing the components of the curable compound so that, when the joining element is inserted, a sufficient and advantageously homogenous mixing of the components takes place.

Preferably, a mixing element for thoroughly mixing the curable compound is arranged in the cavity of the hollow body. The mixing element ensures that the curable compound is thoroughly mixed, thus making certain that the same high anchoring values of the joining element inserted into the hollow body are reached after the curing procedure. The arrangement of a mixing element is advantageous, particularly in the case of a curable compound containing several components and serving as the anchoring agent.

Preferably, the mixing element is arranged movably in the cavity of the hollow body, said mixing element being moved, for example, when the joining element is inserted into the cavity and, in this process, thoroughly mixes the curable compound. Advantageously, the mixing element is arranged in the cavity of the hollow body between the insertion opening and the curable compound.

Preferably, the insertion opening is closed with a closure element that prevents, for example, cement slurry from penetrating into the cavity of the hollow body when the first structural element is being made. Moreover, the joining element protects the anchoring agent that is arranged in the cavity from external influences.

Advantageously, the closure element is a membrane that can be punctured by the joining element and that allows a simple insertion of the joining element into the closed hollow body.

Preferably, a positioning element for positioning and arranging the hollow body is provided in the first structural element, whereby the positioning element is arranged on the outside of the hollow body at a distance from the insertion opening. The positioning element can be brought into contact, for example, with a reinforcing bar of the first structural element or with a section of the formwork of the first structural element, and allows a secure fixation of the hollow body in the first structural element, as a result of which the latter is properly aligned and secured against accidental shifting while it is being made, for example, during the pouring of the first structural element. For example, the positioning element has at least one material section arranged on the circumference and projecting radially therefrom. Especially advantageously, the support element is configured as a ring that encircles the circumference.

Preferably, several hollow bodies are arranged on a carrier element, as a result of which several points are available for achieving a non-positive anchoring of several joining elements. In this case, the carrier element itself can form, for example, formwork on the face of the first structural element.

Preferably, a joint sealing element is provided between the hollow bodies, and said joint sealing element seals the daywork joint, for example, a construction joint, against penetrating water. The joint sealing element is advantageously a commercially available joint tape and also advantageously extends over the entire lengthwise extension of the daywork joint or of the carrier element.

The method according to the invention for creating a connection for non-positively joining a first structural element to a second structural element is characterized by a connecting device with a hollow body that forms a cavity, that has an insertion opening for inserting a rod-shaped joining element, and that has an anchoring agent in its cavity, at least in certain areas, for anchoring the joining element that can be inserted into the cavity, whereby the connecting device is arranged on a daywork joint, for example, on the formwork of the first structural element, for instance, by means of nails. Subsequently, the first structural element is made, for example, poured, a process in which the hollow body is embedded in the first structural element. Then the joining element is inserted into the cavity of the hollow body, whereby the joining element is subsequently held non-positively in the connecting device by means of the anchoring agent. Then the second structural element is made, for example, poured, whereby the joining element, which is already non-positively anchored in the first structural element, is embedded in the second structural element, and consequently the second structural element is non-positively joined to the first structural element.

The joining element is inserted into the cavity of the hollow body, for example, manually, e.g. directly by hand or else by means of a hammer. As an alternative, the joining element is mechanically inserted into the cavity, e.g. by means of a hammer drill, optionally, in combination with an appropriate driving tool. If the anchoring agent is a curable compound, the energy required to insert the joining element can be used for activation purposes, for example, to thoroughly mix the curable compound.

### BRIEF DESCRIPTION OF THE DRAWINGS

The invention will be explained in greater detail below on the basis of embodiments. The following is shown:

FIG. 1—a partial section of a first embodiment of a connecting device in the installed state;

FIG. 2—a front view of a second embodiment of a connecting device;

FIG. 3—the connecting device shown in FIG. 2, in a section along the line in FIG. 2; and

FIG. 4—a partial section of a third embodiment of a connecting device.

### DETAILED DESCRIPTION

Fundamentally, the same parts have been designated with the same reference numerals in the figures.

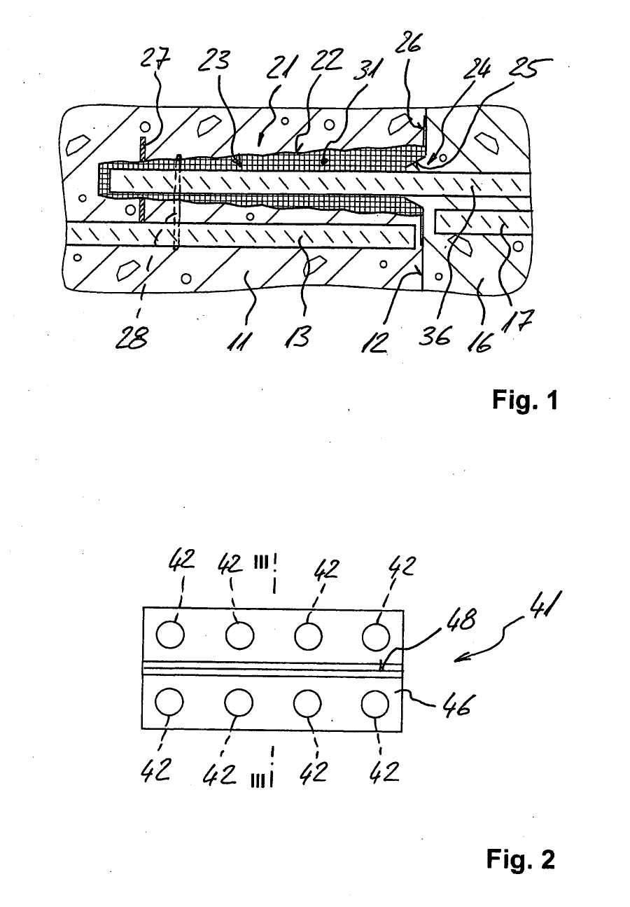

The connecting device 21 shown in FIG. 1 serves to non-positively join a first structural element 11 to a second structural element 16 that is produced at a different point in time from the first structural element 11. A daywork joint 12 is provided between the individual poured structural elements 11 and 16.

The connecting device 21 comprises a hollow body 22 that forms a cavity 23 and that has an insertion opening 24 for inserting a rod-shaped joining element 36, and its cavity 23 has an anchoring agent 31 in the form of a curable compound for anchoring the joining element 36 that has been inserted into the cavity 23. The anchoring agent 31 and the hollow body 22 together form a prefabricated unit. The hollow body 22 is configured to be conical and it is tapered starting from the insertion opening 24. In this example, the outside and the inside of the hollow body 22 are slightly wavy. The insertion opening 24 is closed with a closure element 25 that consists of a membrane that can be punctured by the joining element 36. In the area of the insertion opening 24, the hollow body 22 is provided with a fastening flange 26 that projects radially towards the outside and that allows a simple attachment of the connecting device 21 to formwork. Furthermore, at a distance from the insertion opening 24 of the hollow body 22, a positioning element 27 is provided on the outside contour of said hollow body 22 so that the hollow body 22 can be placed in the first structural element. If the hollow body 22 is affixed onto the reinforcement 13, for example, with a binding wire 28, then the positioning element 27, which is configured here as an encircling ring, comes into contact with a section of the reinforcement 13 in certain areas.

Below, the method for the creation of a connection for non-positively joining the first structural element 11 to the second structural element 16 will be explained making reference to FIG. 1. Firstly, the formwork for the first structural element 11 is made and the reinforcement 13 for the first structural element 11 is laid. Then the hollow body 22 is attached, for example, using nails, to the formwork, which forms the daywork joint. Subsequently, the first structural element 11 is poured, whereby the connecting device 21 is embedded in the first structural element 11.

Before the second structural element 16 is made, the joining element 36, here a reinforcing bar, is inserted through the joining element 25 into the cavity 23 filled with the anchoring agent 31. Guide elements can be provided on the joining element 36 and they ensure a correct alignment of the inserted joining element 36 in the cavity 23 of the hollow body 22. Instead of or in addition to being arranged on the closure element, such guide elements can also be arranged in the joining element for the cavity or in the cavity itself. When the joining element 36 is inserted, the curing process of the curable compound that serves as the anchoring agent 31 is started. After the curable compound has cured, the joining element 36 is non-positively anchored in the connecting device 21 or in the first structural element 11.

Then the formwork for the second structural element 16 is made and its formwork 17 is laid. After this work has been completed, the second structural element 16 is poured, whereby the joining element 36 that is anchored in the first structural element 11 is embedded in the second structural element 16 for purposes of non-positively joining the first structural element 11 and the second structural element 16.

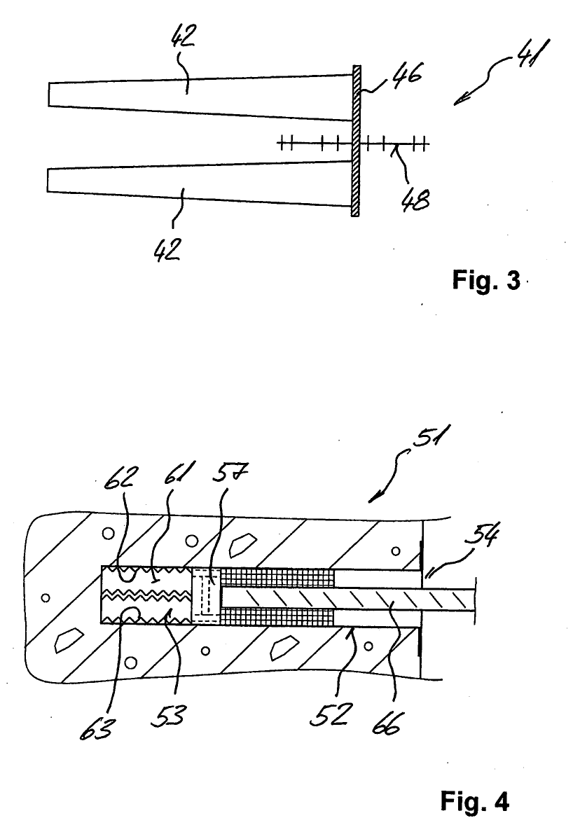

The connecting device 41 shown in FIGS. 2 and 3 has several hollow bodies 42 that are arranged on a carrier element 46. Like the previously described hollow bodies 22, the hollow bodies 42 are also configured to be conical, but, in contrast, they have a straight circumferential surface. In the lengthwise extension of the carrier element 46, a joint sealing element 48 in the form of joint tape is provided between the hollow bodies 42, so that, in the poured state, said joint tape is embedded in the first structural element 11 on the one hand, and in the second structural element 16 on the other hand. The joint sealing element 48 seals the daywork joint 12 between the structural elements 11 and 16 against the penetration of water.

In the case of the connecting device 51, as is shown in FIG. 4, the anchoring agent 61 arranged in the cavity 53 of the circular-cylindrical hollow body 52 consists of a multi-component curable compound whose components are stored in two separate containers 62 and 63 in the cavity 53 of the hollow body 52. Between the insertion opening 54 of the hollow body 52 and the curable compound that serves as the anchoring agent 51, a mixing element 57 is arranged movably in the cavity 53 of the hollow body 52.

When the joining element 66 is inserted, the mixing element 57 is moved in the direction of the curable compound that serves as the anchoring agent 61, whereby the components situated in the containers 62 and 63 are pressed by the mixing element 57 and mixed in it. The mixed curable compound emerges from the back of the mixing element 57, whereby the joining element 66 is surrounded by said mixing element 57 in certain areas and, after the curing of the curable compound, said joining element 66 is non-positively anchored in the connecting device 51.

What is claimed is:

1. A connecting device for non-positively joining a first structural element to a second structural element comprising:
a hollow body forming a cavity and having an insertion opening for inserting a joining element; and
an anchoring agent for anchoring the joining element inserted into the cavity in the cavity of the hollow body, at least in certain areas thereof, the anchoring agent and the hollow body together forming a prefabricated unit.

2. The connecting device as recited in claim 1 wherein the anchoring agent comprises a curable compound.

3. The connecting device as recited in claim 2 wherein the curable compound comprises several components.

4. The connecting device as recited in claim 2 further comprising a mixing element arranged in the cavity of the hollow body.

5. The connecting device as recited in claim 4 wherein the mixing element is arranged movably in the cavity of the hollow body.

6. The connecting device as recited in claim 1 wherein the insertion opening is closed with a closure element.

7. The connecting device as recited in claim 1 further comprising a positioning element for arranging the hollow body being provided in the first structural element, the positioning element being arranged on an outside of the hollow body at a distance from the insertion opening.

8. The connecting device as recited in claim 1 comprising at least one further hollow body, the hollow body and the at least one further hollow body being arranged on a carrier element.

9. The connecting device as recited in claim 8 further comprising a joint sealing element provided between the hollow bodies.

10. A method for creating a connection for non-positively joining a first structural element to a second structural element, a connecting device with a hollow body forming a cavity and having an insertion opening for inserting a joining element, the connecting device having an anchoring agent in the cavity, at least in certain areas, for anchoring the joining element inserted into the cavity, comprising:
arranging the connecting device on a daywork joint of the first structural element;
subsequently, making the first structural element; and then
inserting the joining element into the cavity of the hollow body, the joining element subsequently being held non-positively in the connecting device by the anchoring agent.
